(19) United States
(12) Patent Application Publication
(10) Pub. No.: US 2002/0099577 A1
(43) Pub. Date: Jul. 25, 2002

(54) Virtual production link system

(76) Inventor: Stuart Black, Marina del Rey, CA (US)

Correspondence Address: OPPENHEIMER WOLFF & DONNELLY LLP, 38th Floor, 2029 Century Park East, Los Angeles, CA, 90067, US

(21) Appl. No.: 09/727,732

(22) Filed: Dec. 1, 2000

Related U.S. Application Data
(60) Provisional application No. 60/168,683, filed on Dec. 1, 1999.

(51) Int. Cl. G06F 17/60

(52) U.S. Cl. 705/7; 705/37

(57) ABSTRACT

A virtual production link system, preferably for media production, includes a vendor data base, a service data base, and a budget program to receive vendor and service information. The vendor and service data base preferably include date related information. Input arrangements are provided for production users to input requirements and to receive budgeting information. Access for authorized third parties may also be provided.

### RELATED PATENT APPLICATIONS

This patent application includes the subject matter of Provisional Patent Application Ser. No. 60/161,683 filed Dec. 1, 1999.

### SUMMARY OF THE INVENTION

The Virtual Production Link System (VPL System) is a method of doing business that may link producers of products or services with their vendors 24 hours a day, seven days a week. It also links the parent company of the producer with the producer, which allows for secure high level communication and up-to-the-minute cost tracking and budgeting. As such, the VPL System consists of users (Chart 1, #1), vendor users/equipment and services (Chart 1, #2), and the studio/parent company users (Chart 1, #3). All users are connected through the VPL secure network/data base (Chart 1, #4). The VPL System is a unique combination of integrated software programs: the budget program (Chart 1, #5), the vendor program (Chart 1, #6), and the studio/parent company program (Chart 1, #7). These proprietary programs are the only way to access the VPL network database.

In one specific illustrative embodiment of the invention, a virtual production link system for media production includes (1) a vendor data base including media related vendors for media related products such as video equipment, audio equipment, lighting equipment, etc., and (2) a service data base including media related services such as studio or stage availability, special effects, film or video permits, etc., and (3) a budget program to receive vendor and services information. The system may also include an auction program to permit vendors or service companies to bid on supplying products or services. Also, input arrangements may be provided for coupling production users to the system to input requirements and to receive budgeting information.

Other objects, features and advantages of the system will become apparent from the following detailed description and from the accompanying drawings.

### BRIEF DESCRIPTION OF THE DRAWINGS

FIG. 1 is a schematic diagram of a system illustrating the principles of the invention;

FIG. 2 is a block diagram indicating certain aspects of the system of FIG. 1;

FIG. 3 is a block diagram indicating the relationship between the Production Client (PC), the Virtual Production Link Data Base (VPL DB) and the Vendor Client (VC) data base;

FIG. 4 is a block program diagram from the viewpoint of the Production Client;

FIG. 5 is a block program diagram from the point of view of the Vendor Client;

FIG. 6 includes additional program diagrams involving the Production Client and the budget process;

FIG. 7 is a Production Client User diagram;

FIG. 8 is a program diagram from the viewpoint of the Vendor Clients; and

FIG. 9 is a virtual production link administrative program.

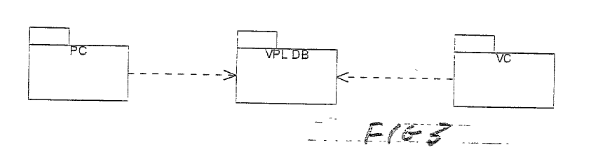

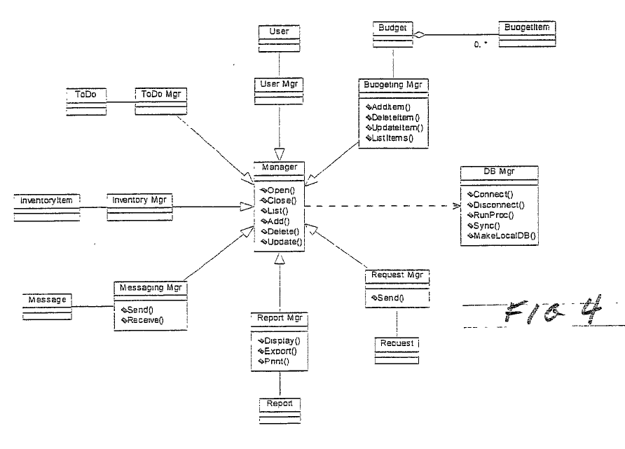

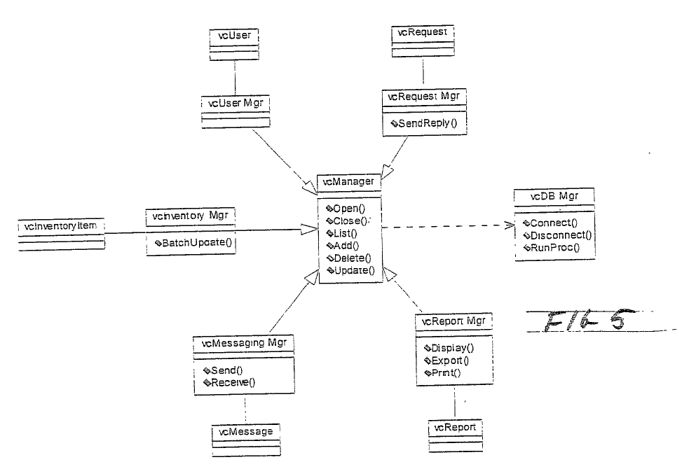

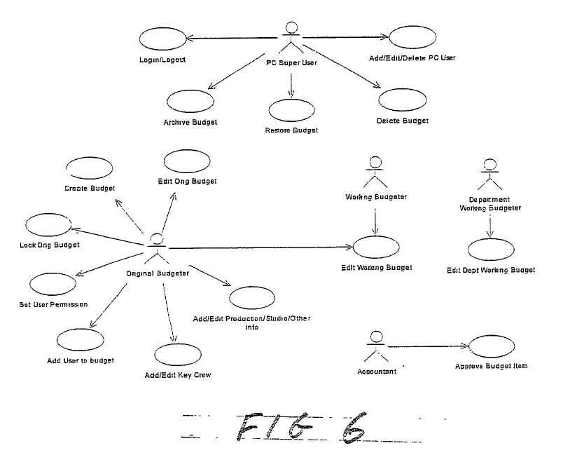

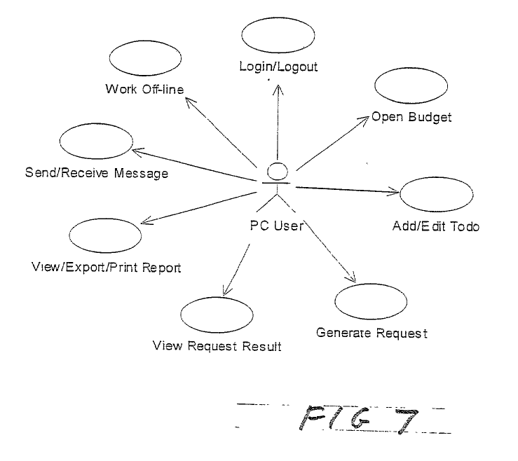

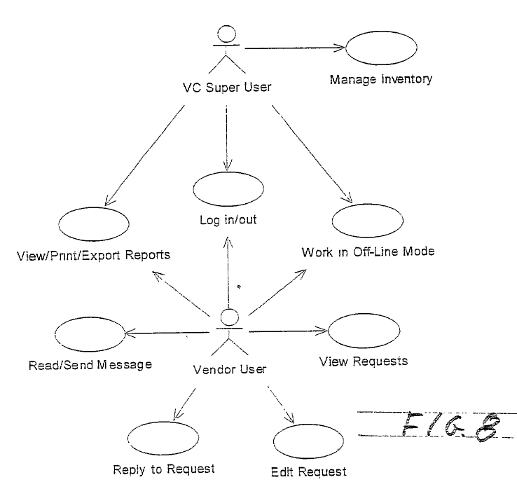

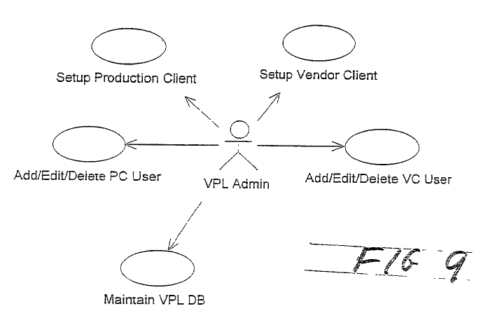

Regarding the drawings, it is noted in passing that FIGS. 3-9 of the drawings are both included within the text and are presented separately.

### DETAILED DESCRIPTION OF THE PREFERRED EMBODIMENTS

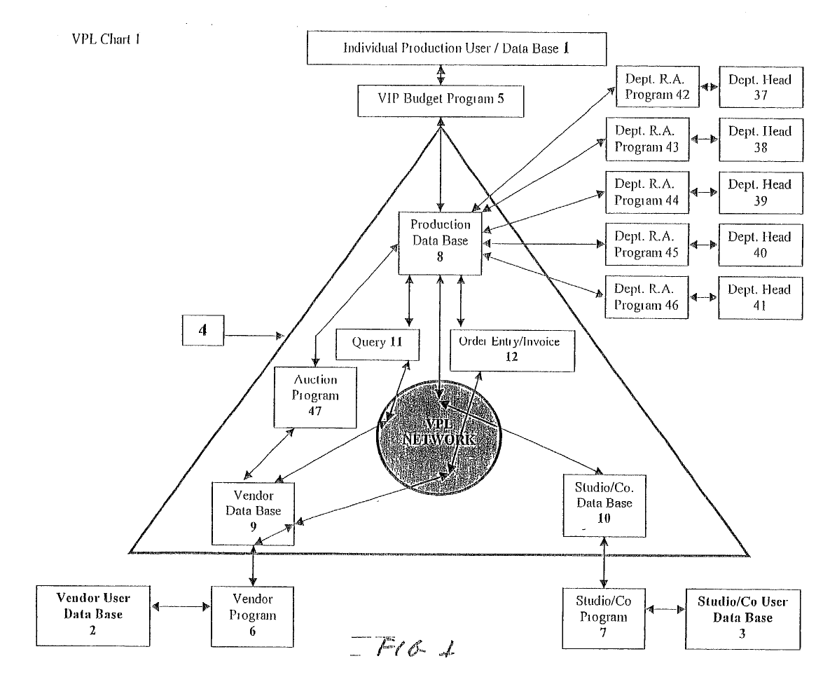

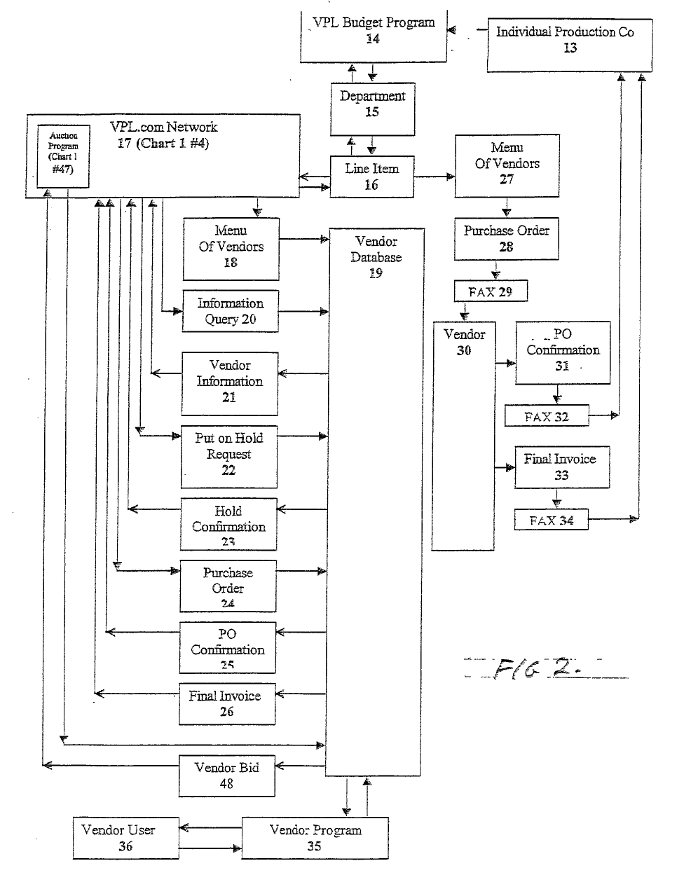

In the following detailed description, the terms “Chart 1” and FIG. 1, “ and Chart 2” and “FIG. 2” will be used interchangeably.

### Primary Users

Each of the users (Chart 1, #1-2-3) will have the proprietary software programs (Chart 1, #5-6-7) that will be the primary interface to the VPL network/data base as well as providing functions such as, but not limited to, budgeting, scheduling, accounting, purchase orders, invoices, inventory control, payroll, cost tracking, bidding, and auctioning.

1. The number of individual production users is not a limited number. Individual production users (Chart 1, #1) will be, but are not limited to: the entertainment industry—major or mini-major studios, major or mini-major independent film companies, feature films/videos, independent films, TV shows, one-half hour, one hour, MOW or mini-series, documentary films/videos, educational films/videos, corporate films/videos, government films/videos, advertising and promotion films/videos, TV commercials films/videos, music films/videos, interstitials films/videos, clips films/videos, audio recording and record industry. The construction industry—major and minor contractors and architects, suppliers of commercial and residential property. These would include, but not be limited to, plumbing, electrical, carpentry, ironwork, concrete, excavating and landscape companies. The VPL System can also be applied to the arts industry, the aerospace industry, agriculture industry, computer industry, as well as many others. Individual production users will use the budget program, a full-service Web- enabled integrated software program. The software also includes a remote access program (Chart 1, #42, 43, 44, 45, 46) that can be used to give a department head (Chart 1, 37, 38, 39, 40, 41) access to a specific department of the budget. The number of remote access departments is not a limited number.

2. The number of vendor users is not a limited number. Vendor users (Chart 1, #2) will be split into two categories: (i) equipment/materials, and (ii) services. Some vendors may be listed in both categories. Vendors will use the vendor integrated software program (Chart 1, #6).

(a) Equipment/materials vendors will be, but are not limited to, camera rental and retail companies, audio rental and retail companies, lighting rental and retail companies, grip rental and retail companies, video rental and retail companies, prop rental and retail companies, expendables rental and retail companies, wardrobe rental and retail companies, set construction rental and retail companies, raw stock (film and video) retail companies, transportation rental and retail companies, construction equipment rental and retail companies, and any other types of companies that could supply equipment for media production. In other industries, vendor would be any supplier to that industry.

(b) Service companies will be, but are not limited to, accounting services companies, payroll services companies, location services companies, stage rental companies, stage services companies, film permit services companies, security services companies, art services companies, food services companies, labor services companies, post production services companies, music services companies, research services companies, legal services companies, creative services companies, special effects companies, promotion services companies, shipping services companies, and any other type of services used by media production. In other industries, service companies would include any supplier of services to that industry.

3. The number of studio/parent companies is not a limited number. Studio or parent company users (Chart 1, #3) are, but are not limited to: major, minor or mini studios, independent film companies, commercial production companies, music video production companies, corporate and industrial production companies, government production companies, television production companies, Web production companies, new media production companies, and any other type of media production company. In other industries, parent companies would include any finance companies, RITs or any parent company that holds responsibility for funding or guaranteeing the production or manufacturing of the product in that industry. The studio/parent company users will use the studio/parent company software program.

### The Virtual Production Link Network/Data Base

The VPL network/data base (Chart 1, #4) is a private, secure and encrypted network/data base linking together separate groups of users (Chart 1, #1-2-3). Each user will link directly to the VPL network/data base via proprietary integrated software program (Chart 1, #5-6-7). The VPL network/data base (Chart 1, #4) will host and maintain all the databases of the individual production user (Chart 1, #8) and the vendor user (Chart 1, #9), and the studio/parent company (Chart 1, #10) on the VPL network/data base (Chart 1, #4). The VPL network/data base (Chart 1, #4) will have proprietary software that will perform searches and analysis of databases (Chart 1, #4-A), as well as providing communications and a portal to the Internet.

### VPL Budget Program

The individual production user will use the VPL budget program (Chart 1, #5), which is an integrated software program that includes an encrypted Web-enabling program that is used to links to that individual production's data base (Chart 1, #8) located on the VPL server. The database (Chart 1, #8) is a full backup of the individual production user database (Chart 1, #1) and is updated automatically and continuously.

The VPL budget program (Chart 1, #5; Chart 2, #14) is an integrated software program designed to estimate and actualize media production budgets. This is a proprietary program that is a Web-enabled integrated software program which includes, but is not limited to, budgeting, accounting, actualizing, order entry, auctioning, scheduling, researching and communications. The VPL budget program is based on industry standard budget forms. The VPL budget program can be used as a stand-alone program. The VPL budget program provides many new innovations and options.

An example of how VPL works is: When one opens the VPL budget program and selects a department (Chart 2, #14), one is shown all of the budget items related to that department. These items will fall into two categories: equipment and services, and labor or crew. Select a line item (Chart 2, #16) and choose to work on-line or off-line.

Choosing off-line will provide you with a database of vendors (Chart 2, #27) related to that line item. You can then select to issue a purchase order (“PO”) to a specific vendor (Chart 2, #28), fill out the PO (Chart 2, #28) and send it via facsimile (“fax”) (Chart 2, #29) to the vendor's fax machine (Chart 2, #30). The vendor will either confirm or reject the PO, issuing a confirmation/rejection (Chart 2, #31) and fax (Chart 2, #32) to the production company's fax machine (Chart 2, #13). When the goods or services have been returned, finished or delivered, then the vendor will issue a final invoice (Chart 2, #33) which will be faxed (Chart 2, #34) or mailed to the production company (Chart 2, #13).

If the user (Chart 1, #1) opts to work on-line, the Web-enabled budget program will automatically link to the VPL network/data base (Chart 2, #17). User is provided with a constantly updated database of vendors (Chart 2, #18). Choose the vendor and user is instantly linked to that vendor's database (Chart 2, #19). All vendor databases are located on the VPL network/data base server (Chart 1, #4).

The user can query information from the vendor database (Chart 2, #20). If the response to the query can be answered from the database (Chart 2, #19), then the answer is instantly seen by the user (Chart 2, #21). If the query can't be answered by the database, then the query is sent to the vendor (Chart 2, #36) via the vendor program (Chart 2, #35) and the answer is returned to the production user via the VPL network/data base (Chart 2, #17).

The production user can issue a “put on hold” request (Chart 2, #22) for goods or services. This request is sent to the vendor database (Chart 2, #19), then to the vendor user (Chart 2, #36) via the vendor program (Chart 2, #35). The vendor issues a confirmation/rejection (Chart 2, #23), which is sent instantly back to the VPL budget program (Chart 2, 414). If the production user accepts the “hold,” then the estimated costs are automatically entered into the estimated cost column on the correct line number (Chart 2, #16) in the budget program. If the production user cancels or has a problem with the “hold,” then the “hold” is sent back to the vendor with comments or new instructions.

The production user (Chart 1, #1) can issue a purchase order (Chart 2, #24) to the vendor by point and click method. The PO (Chart 2, #24) is sent via the vendor database (Chart 2, #19) to the vendor program (Chart 2, #35). The PO is then confirmed/rejected (Chart 2, #25) by the vendor user (Chart 2, #36). The confirmation/ rejection (Chart 2, #25) is instantly sent back to the VPL budget program (Chart 2, #14). The user can accept or cancel the PO. If the user accepts the PO, the estimated amount is entered automatically into the estimated cost column on the correct line number (Chart 2, #16) in the budget program (Chart 2, #14). If the producer cancels or has a problem with the order, a space is provided for a written explanation of the problem. A simple click and the order will be sent instantly back to the vendor for review and/or cancellation.

When the goods/services are returned, finished or delivered, then the vendor will issue a final invoice (Chart 2, #26) which is instantly sent to the VPL budget program (Chart 2, #14). The producer must accept or contest the invoice, which is automatically linked to the PO. If the producer accepts the invoice, the producer inputs his/her “signature” and the final costs are automatically entered into the actual column on the correct line number (Chart 2, #16). The invoice is then forwarded to the accounting department for payment. If the producer contests the invoice, a space is provided for a written explanation of the problem. The invoice will be sent instantly back to the vendor for review.

The production user (Chart 1, #1) can also grant remote access to department heads (Chart 1, #37-38-39-40-41). This is done by use of the “Department Remote Access” (DRA) program (Chart 1, #42-43-44-45-46). The DRA program is on a CD-ROM or can be downloaded. The production user (Chart 1, #1) will give the department heads a smart card and a special password; together they will allow the department head to access the VPL network/data base and the production data base (Chart 1, #8) from a remote terminal. The DRA program (Chart 1, #42-43-44-45-46) will only be able to access the budget items relating to that specific department or budget, items that the producer chooses to include or exclude to that specific department. The DRA program will operate the same as the full VPL budget program (Chart 1, #5; Chart 2, #14), and the DRA programs (Chat 1, #42-43-44-45-46) will constantly update the production database (Chart 1, #8) and be updated by production database (Chart 1, #8).

One of the main benefits of the VPL budget programs is the “auction” feature (Chart 1, #47). The auction feature is a program that allows the individual production user (Chart 1, #1) to select budget items to be put out for auction. The auction program (Chart 1, #47) will link to vendors that can provide the budget item and wish to bid on it. The vendors will send their bid (Chart 2, #48) to the production user via the VPL network/data base (Chart 1, #4).

### Vendor User Program

The vendor user (Chart 1, #3; Chart 2, #36) will use the proprietary vendor program (Chart 1, #6; Chart 2, #35) to access the VPL network/data base (Chart 1, #4; Chart 2, #17) and to interface with the vendor's sales, scheduling, accounting, billing and shipping departments, as well as others. The vendor program (Chart 1, #6; Chart 2, #35) will constantly update the vendor data base (Chart 1, #2; Chart 2, #36), located on the vendor's hard drive which is located on the premises of the vendor's place of business, with information from the vendor data base (Chart 1, #9; Chart 2, #19) located on the VPL server. The vendor program (Chart 1, #6; Chart 2, #35) will also constantly update the vendor database located on the VPL server (Chart 1, #9; Chart 2, #19) with information from the vendor database (Chart 1, #2; Chart 2, #36).

### Studio or Parent Company User Program

The studio/parent company user (Chart 1, #3) will use the proprietary studio/company program (Chart 1, #7) to access the VPL network/data base (Chart 1, #4) and the studio/company database (Chart 1, #10). The studio/company program (Chart 1, #7) will provide up-to-the-minute cost tracking and monitoring of an individual production budget (Chart 1, #5) as well as a secure communications network to the individual production user (Chart 1, #1; Chart 2, #13).

### Virtual Production Link Network/Data Base

The VPL network/data base (Chart 1, #4; Chart 2, #17) consists of a communication network/data base and a network/data base server and/or servers hosting many databases (Chart 1, #8-9-10); Chart 2, #19). There may be as many as 20,000 individual databases maintained on the VPL network/data base. The VPL network/data base will use the most sophisticated encryption and security system available.

The following portion of the detailed description goes into the nature of the Virtual Production Link system in greater detail.

1 Introduction

This document outlines the infrastructure required to implement the Virtual Production Link (VPL) Production and Vendor client applications. VPL provides Studios, Producers, Vendors and other production and supplier entities with company, project and client management functionality and enables them to participate in an Entertainment Industry eProcurement exchange. VPL is a hosted infrastructure for managing the production, supplier and transaction process. VPL is a secured network infrastructure enabling the budgeting process for specific production entities and their associated Vendors. The infrastructure manages the inventory and services and provides connectivity, accessibility, and mobilization on a virtual basis. VPL provides: (a) budgeting, valuation, auctioning, execution, customer service, and efficiency through process aggregation and integration to existing back-office systems; and, (b) an open architecture integrating the production budgeting processes with the bid/offer/PO/invoice processes and other systems for production budgeters, accountants and executives, as well as associated vendors. VPL is used by production entities, including executives, line producers, accountants, and department heads. Users of the VPL request and receive data via secured server communications. The user interfaces display straightforward presentation consistent with user profiles as defined by VPL Administration and designated “Super Users”.

The term “Super User” indicates that the user or entity has been provided a user name and password by VPL Administration and can assign others access rights for both the production and vendor client. “Users” are assigned access from the “Super User” and have access to the functionality of VPL as determined by the access rights.

The major components of VPL are: (1) the production client (PC) including hierarchical budget presentation, budget sub-line processes, reverse-auctioning, crew budgeting and logged request, hold, purchase order and invoice; (2) the vendor client (VC) including PO and invoice tracking, messaging and tiered access control; (3) database synchronization and functionality for off-line access, updates and maintenance.

PC supports budgeting by executives, line producers, department heads and accountants. Budgets and all supplemental memos, production reports and customized functionality are maintained on the VPL secured network. The VPL PC requires integration between budgeting functionality, vendor inventory, scheduling, and production specific data. Original, department and department working budgeters perform budget administration including budget creation, modification and analysis. PC users, by employing tools, protocols and processes to promote budget related state of the art and real time analysis and decision making capability.

VPL requires a database architecture that accommodates both production and vendor clients. A synchronization mechanism manages and accumulates transactions within both the production and vendor clients. Transactions and messages are posted on a real time basis. The production client can review the budget, request, holds, PO's and invoices for inventory and services according to “Super User” preferences. The vendor client reviews requests, holds, PO's and invoices for inventory and services according to “Super User” set rules. Inventory is displayed to vendors and clients with prices established by applying a rate card or as designated by vendor pre-specified rates.

The database synchronization and management requires: (1) effective interfaces between the budgeting, PO and invoice processes; (2) integration of PC and VC information; (3) cleansing functionality; (4) report generation modules; and, (5) scheduling modules. These functions permit VPL users to reference budgets, review budget lines, update information, generate analytics, evaluate requests, and conduct business in a close to real time environment.

This document is a guideline for the development and implementation of VPL's PC and VC. The information presented includes diagrams (in the attached “Appendix A”) and documentation regarding business logic, data objects, processes, techniques and interfaces. The document is based on requirements gathered in the discovery process and implementation review. The recommendations have considered NT deployment using Microsoft and other standard products and tools. Databases deployed are ODBC compliant, including DB2, SQL 7, Sybase and ORACLE 8. Web Trends Enterprise Suite or Hitlist Live will be deployed for analysis of server traffic and demographics.

1.1 System Purpose

Based upon extensive market data and experience in the entertainment industry, it has been determined that there is a long-felt need for intelligent electronic budgeting and electronic communications between production and vendors. VPL is the facilitator for budgeting of productions.

Production entities require an infrastructure to more effectively manage the production process for the entertainment industry. Production budgeters require: (1) effective representation of budgets; (2) tiered user access to promote control and usability of the budgeting process; (3) tools to facilitate service and product acquisition; and (4) automated tracking and logging of requests, holds, purchase orders and invoices.

Vendors to the production industry have a need for infrastructures whereby they can (1) develop a presence for real time auctioning of services and products; (2) maintain their differentiating characteristics; and, (3) effectively provide integrated tools and sales interaction to their clients to facilitate more efficient management of inventory.

VPL's tools, data integration and interfaces are developed with an open architecture and an ODBC compliant database. The open architecture is intended to support the opportunity for customization to enable differentiation between individual Vendors, participating in the VPL's network. When VPL is employed, its tools provide a powerful budgeting presence for users involved with the production processes and its vendors providing products and services. Both vendors and production clients become more efficient and effective.

VPL budget users are production entities, which are budgeting specific productions including film, television, and commercials. Each studio has multiple productions with multiple executives (known as “Original Budgeters” to VPL), line producers (known as “Working Budgeters” to VPL), Department heads (known as “Department Working” to VPL), and Accountants (known as “Accountants” to VPL).

VPL vendor users are service and product providers, which have specific relationships with productions (film, television, music). Each vendor may have multiple users of VC to manage inventory and clients, PO's, requests, invoices, etc.

PC permits budget creation using either a VPL or user provided template. For each production, the budget attributes and users to that specific production are defined. Users have access to various lines or functionality as defined by the Original Budgeter. Additional PC functionality includes order tracking; reverse auctioning, such that users are able to review and post requests of vendor inventory.

VPL also processes requests, purchase orders, holds and invoices, and posts them to both the PC and VC. Additionally, VPL maintains and archives budgets and transactions. This combination of postings, secured data maintenance and archiving enhances the usability of budget-centric information and simultaneously enhances the efficiency of transaction flow.

Budgeting, analytics, and reporting functionality should be close to a real-time generation and display in order to promote real-time budgeting and to be of value to the production studios and their budgeters. The database and information flow to the analytics, budgeting, purchase orders, invoice, scheduling, and inventory systems must accommodate vast amounts of production-related information, which is procured from various sources including links, feeds, and documents.

VPL provides a single point of access by which studios and their budgeters may review budgets, variances, vendor and inventory information, transactions, order history, and exploit available information. The intended results are convenient stand-alone or server-based tools to view production details and vendor related information. Effectively managing the data, generating information and displaying information in a user friendly and searchable manner, entices VPL vendor and production users to revisit the VPL and to transact using VPL's interface.

VPL infrastructure provides the following functionality:

Budget facilitator, which posts and updates the budget tree of a specific production.

Budget view based on unique 4 level hierarchical approach.

Maintenance of budget specific To Do List.

Display and reporting of production related reports.

Crew Budgeting and scheduling.

Hot Cost Tracking.

Vendor product and services facilitator, which posts and updates requests, purchase orders and invoices for inventory or services.

Vendor client posts and updates pricing information to reflect specific rate cards as defined by the vendor.

Vendor enabled client differentiation for purposes of pricing and rate card generation.

Updates to the vendor inventory are reflected on both the vendor and production clients.

PC and VC inventory and rate cards are updated by VPL on a real-time basis. VPL employs messaging among VPL users, preferred vendors and production specific users.

Maintenance of production staff information with key crew and screen credit designations.

Integration of multiple data sources for budgeting and other industry standard data vendors.

Cleansing of all information before addition to the vendor and production databases.

The analytics engine generates reports for review of cross budget performance.

1.2 Overview Diagram

The system is specifically designed to enable content rich budget display, order tracking and analytic generation for budgeting purposes, while supporting the businesses of production companies, studios and vendors. Special care will be taken to ensure maximum flexibility and promote the integrity of all production processes. The system design will handle data from both internal and external sources. The functional design promotes a scalable, secure, robust, and simplistic design. The outlined design and implementation focuses on requisite functionality.

The attached diagram depicts the relationships between the major logical components of VPL. The attached diagram presents a high-level view of the logical functions of VPL (see, Logical Functional Diagram in the attached appendix “A” which includes a collection of drawings and diagrams associated with the system).

2 Required Functionality for Production Client

2.1 The Production Client (PC) Overview

VPL provides tools to make the budgeting process more effective and efficient. The concept of “budget-centric” is propagated throughout the PC. The PC enables production users to review, analyze, and customize budget related and transactional information to support a more efficient and effective budgeting process.

All interfaces and functionality are built to accommodate the production process for executive, line producers, department heads, accountants and other production entities. To effectuate ease of use consistent with the media production business, VPL supports the comparison, combination and side-by-side manipulation of both budget and transactional information.

The PC has several tiers of access: 1) the original budgeter creates the budget, assigns users to the budget, generates the original budget, and locks the budget; 2) the working budgeter uses the original budget as its benchmark to further detail the budget, typically working at the department level; 3) the department working budgeter typically works with the line view of the budget and uses the department budgeters estimates to budget to a greater granularity.

Budgets are created and saved to a database with budget identifiers, including budget estimates, memos, and messages, to-dos and reports, as determined by Super User or Original Budgeter preferences. Budget estimates are generated to the sub-line level. Also, all estimates are stored in the budget database with original, working and department working values. The system supports aggregation of sub-lines, lines and other higher levels of the budget hierarchy. Also, the system supports limited access to the budget tree, including non-sequenced access.

Estimates and variances are generated for all budget lines in the PC using the Original budgeters designated variance preferences. Variances are highlighted throughout the system via the PC's scorecard.

An important feature of the PC is the facilitation of sharing of the budget along with real time budget updates.

PC treats the production accounting as the system of record for budgeted productions. For each user of the PC, the accountant users have limited access to the system to approve purchase orders and invoices and review other designated information. Approved invoices are electronically downloaded to the accounting or other system.

Requests for information and holds and purchase orders are generated on a real time bases. The transactions are captured by VPL and forwarded to the Vendor and saved to the VPL database.

The system also archives in a separate table any budgets for which the VPL administrator or PC Original budgeter or super user designated.

There is a close nexus between the PC and the VC. Requests for quotes and holds, purchase orders and invoices are mirrored in the VC and become actionable based upon Vendor and/or PC authorization. PC actions in placing purchase orders through VPL affects the authorized totals for the specific production. Updates in purchase orders result from vendor or client updates changes the bottom line of the production authorized total and is reflected by the invoices issued by the Vendor.

The PC features must be carefully integrated with the VC to promote real time analysis and budgeting for productions along with more efficient management of inventory and clients for vendors.

The Production Client system provides budgeting, reverse auctioning, scheduling generation of the requisite forus and supporting material, and customized integration with scheduling and back office production systems for a true “Virtual Production Link”, that is paperless, secure, and network enabled.

PC features supported include:

Budgeting is controlled by authorized personnel (e. g., Unit Production Manager, Line Producer, Accountant) and available to selected users on a segregated basis according to their function.

Super Users, such as Studio Production executives, are able to access all data.

Users are restricted to designated areas (e. g., Transportation Department Head can only see Transportation data).

Requests for bids for Equipment and Services are transmitted to all participating Vendors on a 24/7 real time basis.

Reverse auction ensures lowest prices and discourages “kickbacks”, as responses are recorded and tracked. “Hot Costs” tracking and reporting is accommodated.

Crew budgeting is enabled, which interfaces with scheduling functionality.

2.2 The Budget

VPL's interface and data maintenance is based on a budget-centric view. The budget is the basis for tracking costs, writing POs, and managing the overhead of a production. All requested quotes or holds and purchase orders have budget lines associated with each requested item in the transaction. Returned requests, holds and purchase orders can be applied to the appropriate budget sub-line.

Budgeting occurs both online and offline to facilitate offsite productions. For budgets being managed with a connection to the VPL server, transactions, additions, deletions, and modification to the budget, are managed on a real time basis. For budgets being managed and worked on without a VPL server connection, the transactions and all modifications must be logged and maintained for a later synchronization. Updates must occur on a timely basis in order to add value to other PC production specific users.

Vendors broadcast updates of rate cards and inventory. Users can request a scheduled update of vendor data or make an ad hoc request.

2.2.1 Budget Coverage

Budget types to be supported by VPL for budget and vendor management are listed below. The indicated codes are employed for mapping and archiving purposes.

Code “tpComm”: Commercials

Code “tpTV”: Television

Code “tpFilm”: Feature Film

2.2.2 Budget Tree

Budget lines of a production budget are managed as a four level hierarchical tree. Each node of the tree contains both a number and text identifier.

Templates are provided by VPL, which resemble the book of record used by commercial, film and television production budgeting and accounting.

The top level of the tree indicates the production name and identification. This level contains the bottom line of the budget.

The second level includes summary lines, such as Above the Line, Production, Post Production, and Other Line, and is depicted by the 1000's line aggregate numbers.

The third level includes department totals such as Talent, Art Direction, Camera Operations, Production Film and Lab, and Titles that are depicted using the 100's in the line numbers, such as Editing 5100, Post Production Film 5200.

The fourth level includes the budgets line (A.K.A. general ledger numbers), which is a number depicted to the 1's, such as 4001-Production Raw Stock.

The fifth level contains the sub-line level that is depicted using decimals, 1st Unit Normal Negative 4001.01.

2.2.3 Budget Templates

Templates are available to all users for commercials, television and film productions. The templates contain the standard general ledger tags and schema along with VPL's proprietary sub-line enumeration for budgeting of specific items and services. Templates contain 5 levels creating the schema for the budgeting hierarchy. Each level of the tree represents a summation of lower level branches and nodes.

Branches and nodes may be re-assigned general ledger numbers and text for both display and database purposes. Note, levels of the tree must be assigned numbers according to the sequence for which the tree is to be displayed.

Each level of the tree is an aggregate total of either the subsequent branches or the nodes at the base of the tree. The top level requires no numeration, but contains a textual header. The second level of the tree is enumerated with the 1,000's and contains textual tags. The third level of the tree is enumerated with the 100's and contains textual tags. The fourth level is enumerated using 1's and contains textual tags. The final level of the tree contains sub-lines using decimals (0.1 to 0.001) to enumerate the base nodes. The nodes also contain textual tags.

2.2.4 Budget Creation

Original budgeters are the only users of the PC with budget creation functionality. When creating a budget, the production type and production identification is required. The original budgeter is also prompted to enter key crew, production and studio information and other generic information. The production budget templates along with any budgeting transactions are saved in the database using the designated production id. Once the production is create, the system prompts for the production title, start and end dates, and shoot dates.

New budgets are created with the un-locked status. At this point, only the original budgeter can modify or add to the budget. The original budgeter is also prompted to enter key crew, production and studio information, and other generic information.

2.2.5 Budget Locking

Once the original budgeter is finished with its estimate or decides to open the budget for other users, the original budgeter locks the budget. All locked budgets are available to other designated users of the specific locked budget. Note, locked budget templates, including general ledger numbers and related text, cannot be modified or deleted, even by the original budgeter.

2.2.6 Budget Work Offline

Budgeting is supported offline for VPL users who do not have access to VPL secured servers. Only VPL users with the appropriate software and database on their local machine are able to work offline, saving all transactions to their local databases. All database transactions are time stamped and added to a database transaction log for later synchronization.

Once the user has VPL server access, the database can be synchronized at a specific time or at the PC user's request. All records are uploaded to the server. Records are subsequently updated and update notices are sent concurrent online users of VPL who are accessing the specific updated budget. When database conflicts arise, the VPL database administrator resolves issues and/or contacts the PC user who generated the data in question.

2.2.7 Budget Work Online

Budgeting online is available for all PC users. Anytime a PC user transacts to the database with a read/write, the transaction is logged and sent to VPL's server in real time. Users working online are able to view the affected modifications on their next screen refresh.

2.2.8 Budget Save/Save As

Budgets can be saved or renamed by the original budgeter. This process is enabled before the budget is locked and available to other VPL users. The “Save As” functionality permits original budgeters to work with the budget and

2.3 Budget Administration

Budget administrators and original budgeters maintain details pertaining to key crew, cast, production offices, and users. Details include contact information and other specifics, which include cast compensation and representation, screen credit tag, tree structure for displaying key crew by title.

2.4 Calculations

2.4.1 Scorecard

The scorecard is used to monitor the overall variance of the budget. Additionally, a line or more detailed scorecard is displayed to monitor the line(s) for which the user is budgeting and reviewing.

The calculation engine must provide tools for identifying variance and updating the scorecard. Variance is generated for each sub-line, line, department and header. Analytics generated are processed using the Original budgeters definition for variance. The definition is either:

Budgeted versus authorized

Original versus Department

Department versus Department working

2.5 Budgeting Process

2.5.1 Traversing the Tree and Budget Information

The budget tree is a hierarchical representation arranged by the numerical tag sequence. All nodes have labels and numbers attached. The tree expands at each node and appears as a hierarchical representation of the budget.

Budget information is viewable at the sub-line information, where all supporting memos are saved for reconciliation purposes. When traversing the tree to higher levels, aggregate totals are available via a spreadsheet interface, which display the line, department or total headers aggregate total.

Note, users with limited line access are provided the same limited view of the aggregates and sub-lines. A higher-level user determines the limited view.

Sub-line details contain all details of the budget, either obtained from a vendor request, hold or purchase order or entered ad hoc from a specific user. This level of detail provides sufficient detail to budget for specific items used in productions.

2.5.2 Reviewing Budget Information

Budget lines, sub-lines and aggregated category details are reviewed through a spreadsheet interface. The PC view is dependent on the budget tree's location. The view is modified to wherever the user selects from the budget tree. The view is updated with aggregate totals when a higher level is selected.

2.5.3 Budgeting

PC users budget according to their permissions and functionality. Original, Working and Department Working budgeters have different views of the budget, according to higher-level budgeters assignment. Budgeters are assigned designated budgets to work, such as original, working or department working budgets. There are two views provided to each user, the original and working view. Depending on the user type, the original or working is read/write while the other view is read only.

For the highest tier user a.k.a. Original budgeter, typically the executive, the original and working views are of the original and working budgets. The original budget is read/write and the working budget is read only, The working budget is assigned to PC users at a lower tier to manage.

For the second tier user a.k.a. Department budgeter, typically a department head, the original view is the department budget and the working view is the department working budget. The Department budgeter has read/write access to the Department budget and read only access to the department working budget. The working view is assigned to other PC users who are at the lowest tier of the budget.

For the third tier user or the Department Working budgeter, typically a line producer, the original view is the working budget and the working view is the department working budget. The Department Working budgeter has read only access to the working budget and read/write access to the Department Working budget.

Once the budget is created, a PC budgeter can add items to budget lines using the sub-line memo process or via returned request for quote or request for hold. Budgeted items are written only to the budget and lines for which the specific user has access. All budgeted items must be ascribed to a budget sub-line.

The sub-line memo process permits users to enter estimates into the budget without a vendor inquiry. The sub-line process is initiated from the budget line details window. Specific sub-lines are reviewed and budgeted by traversing to the sub-line item of interest and summoning the sub-line memo child window. The sub-line memo child window logs all activity to the budget sub-line, including additions, deletions and comments regarding the budgeted sub-line.

2.6 Generate Hot Costs

Hot Costs are overages, which are calculated on a daily or regular basis. Hot Costs are calculated for labor, cast and crew with focus on meal overages, overtime and other additional labor costs. Rate cards or manual entry via the Assistant Director input function can account for labor hot costs. Hot Costs are also calculated for film usage. Film usage hot costs can be entered via the film usage report or via manual entry to a hot cost form.

Other overages for Equipment or Services can be accounted for by demarking purchase order lines with the hot cost tag. The purchase order “Use date” is the date for which the hot cost is triggered.

2.7 Manage Production Crew

Crew for new productions are updated using VPL's interface. Crew, which are already included in VPL's contact list or found on other productions, have information available to the PC. The PC can select crew personnel from the contact list or enter information about crew via VPL's interface.

Budgeting for production crew required 2 types of data:

Deal Memos contain all personal information related to the individual crew members. Details of the memo include name, address, Social Security number, screen credit, alternate contact, phone, fax, pager, mobile numbers as listed on the “contacts” page. Information related to rates for each specific crewmember is also outlined. Rate of pay is available for build, prep, shoot, wrap, strike days, overtime, kit rental, mileage, and travel. Union affiliation and Union Rules are maintained to calculate affected pay rate due to hazard pay, holidays, consecutive days as denoted by the Unions.

Schedule data pertaining to crew is facilitated via the crew sub-line input screen and by the Department scheduler. Sub-line input screen allows more generic input of number of build, prep, shoot, wrap, strike days and rates for generic services for those days. The Department Scheduler displays all crew within the department on a calendar. Crew are listed by day and type of work i.e. build, prep, shoot etc. Crewmembers time is managed by using Department Scheduler and Crew Sub-line input screen in tandem. Crewmembers can be easily dragged and drop to the Department Scheduler's calendar for budget purposes. Note, in version 2.0 crew will be tagged to scene numbers to allow automatic crew rescheduling as the shooting schedule is rescheduled.

2.8 Maintain To Do List

To do information is maintained by PC for tasks. Each user can add, modify or delete tasks, which are generated by the specific users. Assignment of tasks is permitted where higher-level users can assign task to subordinate users. Assigned tasks are catalogued and are available only for review by the assigned user or higher-level users.

2.9 Manage Reports and Forms

Report templates and forms are managed via PC's file cabinet. VPL maintains templates for commonly used forms, including “Production Report”, “Call Sheet”, “Day Out of Days”, “Hot Costs”, “Shoot Schedule”, “Break Down” and “Distribution List”. The file cabinet stores information to a PC folder on the personal computer as per the user's request. Backups are performed upon synchronization. Ad hoc backups can be requested to either the personal computer or VPL server. Forms can be shared with other users or demarked for private reference.

2.10 Manage Vendors

Preferred vendors of studios can be uploaded or entered via VPL's Administrative interface. Information including contact details and line number or category for which the vendor is typically associated is also maintained. Negotiated rates can be assigned per production or per studio or specific type of production, e.g. commercials, feature film or industrial film.

2.11 Scheduling

Version 1.0 will not accommodate imports or interfaces to third party schedules, such as Movie Magic Scheduler. Instead, PC provides an interface to schedule crew and build out daily rate cards and budgets given the details of the crew memo and amount of time budgeted.

Later versions will support customization using VPL's integration group or standard imports from third party scheduling programs like Movie Magic Scheduler. These scheduling programs are based on the “script breakdown”. Accordingly, the schedule and breakdown pages are distributed via the VPL network.

The PC's scheduling function is budget centric in that the crews cost is based on the amount and type of time or days scheduled. Equipment and Services costs are directly related to scheduled times of use. These sources of data are combined in the schedule functionality to create an overall schedule of crew and equipment and services, which can produce variance reports to answer questions such as “What will it cost to shoot 2 additional days?” A large segment of production cost are linked to time. Accordingly, scheduling functionality facilitates adjustments in time to appropriate line items when required. This function requires corresponding data from Vendor's which is dependent on goods or services usage adjustments which is linked to the calendar/schedule. “What if” scenarios will be accommodated to review variances associated with changing schedules, services and goods.

2.12 Crew Budgeting

Crew budgeting integrates the production schedule and call sheets or detailed rate cards specific to each member of the crew. Budgeting for crew requires neither purchase order nor invoice. Crew budgeting can be processed either via the budget sub-line memo entry, see 2.5.3, or via deal memos.

Deal memos are typically used to facilitate the crew budgeting process. The deal memo form integrates data from budget sub-line memos, crew calendar, and crew contact details to generate the deal memo. Deal memos, like purchase order, must be authorized by super users. Note, the crew budgeting process requires precise scheduling of resources employing specific crewmember rates.

To generate a preliminary estimate for a crewmember, the original budgeter traverses the tree and finds the appropriate line for which the crew member(s) labors costs are budgeted. The estimate can either be for a specific crewmember for which actual rates are available or for a generic crew member for whom estimates of rates and hours worked can be entered.

To generate the line producer's budget, A.K.A. department working budget, along with tracking hot costs and actual labor costs, the department working or department budgeter, or UPM must use the actual crew member's rates, hours worked and kit rental charges when appropriate. Note, crewmember details can be entered via an administrative user or by an authorized user.

Crewmember requisite information for crew budgeting includes all contact information; hourly, overtime, holiday pay, turn around time or other budget specific rates; and, typical line number for which this crew member is assigned. Note, templates can be saved with crew specific budgeting information, excluding all contact information. These templates can be reused within the budget and across budgets.

2.13 Archive

Budgets and all associated data is stored on the VPL server. All data falling within the scope of a budget can be stored and archived on the VPL servers. Storage not only includes data, which is managed currently on the VPL server, but also any additional information managed by the PC or VC stored on the PC, e.g. location stills, set drawings, script notes.

Administrative or super users originate this process. The archiving functioning removes all budget related information from the archiving user's personal computer and saves it to the VPL archive. Additionally, the budget is demarked archived and can no longer be modified by non-super users. Note, super users have access to the budget for addition/modification of purchase orders and invoices. Additionally, the request initiates a like request to other budget users, informing them that the budget is closed and provides other budget users the opportunity to archive their budget data.

3 Required Functionality for Vendor Client Implementation

3.1 Overview

The Vendor Client (VC) employs software to display inventory, publish pricing information and facilitate invoice and transaction processing.

The vendor databases reside on the VPL server with real time updates to synchronize production and client vendor related transactions information. The VC receives requests (rfq), request for hold (rfh), orders (PO) and tracks its transactions accurately and around the clock, 24 hours a day, 7 days a week.

The VC receives purchase orders, requests of information and holds, and returns a confirmation regarding availability and specific costing, to the production. The PC initiates these requests. The requests are managed by VPL and routed to the VC for vendor review. Confirmations and modifications that are generated by the VC and sent back to the PC initiator include tracking number, which are employed to track the entire transaction process. All messaging is saved and available for review.

The Vendor Client functionality includes:

Network-Enabled services and automation, providing a link directly to the Vendor's database on the VPL server, via the VPL Network.

Posting and messaging of inquiries, RFPs, RFHs, RFQs, POs, and invoices.

Client management, which integrates with the back office systems. Visual and audio demonstration of services and products, which include schematic drawings, animation, or video/audio clips to demonstrate their product(s) or service(s).

Reverse auctioning.

Vendor Client is based on a User hierarchy. This function allows the Vendor to assign Users with specific functionalities, such as assigning specific customers to one sales person or permitting scheduling personnel to see all pertinent information but unable to see rates or prices. The User function is fully customizable to the Vendors needs or method of operation. Some typical Users are: System administrator, Head of Sales, Sales personnel, Scheduling personnel, Accounting personnel, Shipping/inventory personnel, Executive management. Parameters can also be placed on Users, such as requiring an authorization from another User before confirming an order or rate or schedule, among other parameters.

The VC uses the familiar look of “Outlook” as the primary interface and will import and export to other programs like Access or Act. The VC receives Request for information or prices, hold requests, and purchase orders via the VPL Network. The VC can be used off-line, in which case orders or requests made by phone or fax are manually input into the standardized forms provided by the VC. Once the data is in the system it is shared with the appropriate Users within the Vendor Company.

The VC provides an instantaneous response to customers by sending out quotes, information, confirmations and invoices electronically. VC greatly improves customer relations and efficiency by eliminating paper and providing an auditable archive of all transactions.

The VC can be customized to respond using their specific in-house accounting system specifications. The VC also includes client management functionality. Vendors automatically receive filtered information about the production or customer. For example, a vendor of Film Lab receives information on what type of cameras are in use, the name of the DP and all the names of the camera assistants on the production along with standard info such as Director, Producer, production staff and office info.

Also, VC provides a secure messaging service between the Vendor and their customers via the VPL Network.

VPL hosts the Vendor's database on the encrypted secure VPL server. The database is a complete backup of the Vendor's database consisting of inventory, pricing and accounts. This provides a higher level of security and eliminates the need for vendors to create and maintain a web site on an ISP. The Vendor's VPL database constantly syncs with the VC database on the Vendor's assigned computer located at the office or anywhere the Vendor wishes.

VPL will create and maintain the Vendors Web site on our servers thereby eliminating the need for each Vendor to build and maintain their own site. The site will include listings, descriptions and prices of the entire inventory of equipment or services. When applicable, VPL adminstration sets up the system in the Vendor's office and train- designated personnel in its functions.

The VC has the ability to include graphics, schematics of equipment video clips that demonstrate uses of equipment or services. This will give the Vendor a great opportunity to educate customers about the advantages of their equipment or services.

The Vendor's customers will be able to order equipment or services 24 hours a day 7 days a week from anywhere in the world.

VC integrates the Vendors order entry system with the VPL Production Client Software to provide the Production client with up-to-the-minute information on the availability and pricing of their equipment or service. This can be provided using standard rates or customer specific rates.

VC interfaces with the Vendor's accounting system in order to identify the Production Company as an open account or new account. If the customer needs to open an account, the customer is instantly provided with the necessary forms. If the customer has established rates they will see those rates. VPL has taken every precaution to ensure that only the Production and the Vendor have access to rates.

Billing Clients through the VPL secure link will make the billing process extremely efficient and fast.

VPL can provide Vendors with statistical data about their accounts and about their market segment and the industry as a whole. For example; how many customers were not able to use their equipment or service because it was unavailable.

Vendors will be given the opportunity to advertise on the VPL system getting their message to their target market.

VPL is Global. The benefits of global exposure cannot be overstated. Vendors will have access to customers and markets in all major centers around the world. VPL is the most cost efficient method to expand Vendors market reach.

VPL incorporates state of the art security protocols and encryption to ensure Vendors and Clients privacy.

Vendors are included in a “reverse auction” function; this function allows the production to elicit bids from Vendors. This provides a means to expand the Vendor's base.

3.2 Manage Inventory

Inventory is managed through a robust interface. Inventory is both added and modified through the VC interface or through a batch update mode. Inventory management is provided to customize rates for PCs and link inventory and services directly to line items.

Inventory interfaces are provided to manually enter all inventory information, including serial number, description, category, sub-category, unit of sales, and various rental rates when appropriate, such as daily, weekly or monthly. Vendors may also select to link inventory or services to various budget line items.

3.3 Process Purchase Order

Purchase orders are sent to VCs from PCs. Subsequently, VC's respond with either a partial, full or denied status. Denied indicates that the VC denied the purchase order. The partial order indicates the VC can fill part of the order. Full indicates that the order can be filled against the purchase order requirements. Modified indicates that the VC has modified the request either by suggesting alternative product mix or dates available. Note, filled orders are processed and later invoiced.

The purchased order confirmation (full, partial, modified or denied) is returned to the PC. Modified and partial orders are reviewed and either ignored and archived or modified/accepted and returned to the VC.

3.4 Process Invoice

Invoices are generated from either the purchase order or using the VC interface. For invoices generated from PO's, the invoice is linked to the purchase order for easy review. Note, invoices are sent over the VPL network with exhaustive audit trails.

3.5 Generate Reports

Reports are generated to list details of purchase orders, requests for quote, request for hold and invoices. Reports are generated by client, transaction number, date, transactions type (purchase order, request for quote/hold, invoice) or status (open, closed, paid, partial).

Reports are displayed using the VC interface. All reports have printing and save as functionality.

3.6 Archive

Inventory, invoices, requests for quotes, purchase orders sent from PC users and associated data are stored on the VPL server. Administrative or super users originate this process, enabling efficient management of the workspace.

Archive requests trigger data to be removed from the Vendor workspace and sent to TBC archive, where it is compressed and saved to archive servers. If vendors require viewing the archive data, they must send TBC Admin a request for archive restoration. Subsequently, data is restored to their workspace and demarked as restored.

4 Required Functionality for the Database Synchronization and Maintenance

4.1 Overview

Data replication and synchronization is a key component in the VPL system. Due to the size of the VPL database and the need for off-line budgeting (no database connection), the PC application caches the necessary portions of the central VC/PC database on a standalone machine. The cached data includes budgets and slices of vendor inventory. Data replication introduces data synchronization and consistency problems. Fortunately, these problems can be easily overcome by using the Microsoft Jet Database Replication engine. Microsoft Jet was designed specifically to address these problems.

4.2 Synchronization Mechanism

VPL PC users update budgets on their local machines. At any time during a working session (providing they are connected to the VPL network) or when the user is satisfied with their updates (and connects to the VPL network), changes can be committed. The commit operation engages the synchronization process to transmit the updated database records to the central database. Other users connected to the VPL network and affected by the changes will get the updated data appropriately.

Microsoft Jet replication tracks and records all changes in each database replica, including the master database. When it comes time for synchronization, Microsoft Jet replication only updates records marked as changed. This is a bidirectional process. If two replicas simultaneously update the same record at different replicas, Microsoft Jet reconciles the updates (discussed below.)

Microsoft Jet replication uses incremental replication. This means that, during a single synchronization between two replicas, the only updates made are those resulting from changes made since the last synchronization. This provides significant benefits over method of data distribution that transmits the whole database whenever new data or objects require distribution. Each record in a replicable database has a generation counter; Microsoft Jet replication uses this field to control incremental exchanges. Microsoft Jet replication also records the maximum generation in the local database.

The Synchronizer is the Microsoft Jet replication agent that performs the actual synchronization. The Replication Manager provides the automated scheduled background exchanges between replicas. These exchanges can be made while two replicas are directly connected, or through a file-system transport that does not require a direct connection for the exchange. In either type of transfer, the Synchronizer collects the changes at one replica and transmits them to other replicas. If the file-transfer system is used, one replica must deposit changes in a temporary file. The Synchronizer, initiated from the target replica, collects the updates at a later time and applies them to the target replica. This is a great benefit for rarely connected users; they can post changes whenever convenient rather than depending on an available connection.

Microsoft Jet replication supports two styles of synchronization: direct and indirect.

Direct synchronization is when the synchronization process has a “direct” connection to both replicas and is able to open both replicas simultaneously. Updates are immediately read and written to both replicas.

Direct synchronization is the default method used by Microsoft Jet replication and is ideal when the replicas are on a LAN. The synchronization is fast and reliable. In addition, direct replication does not require any additional configuration or processes.

Indirect synchronization is when there is no direct connection to the remote replica. Instead the local replica collects its updates into a “message” file, which is written to a predetermined location, referred to as a “dropbox folder”. At some later time, the remote replica looks at its dropbox folder, reads the message file and applies the updates. Indirect synchronization can either send the message file over the file system or Internet/intranet. Microsoft Replication Manager is used to initiate the indirect synchronization process.

If an exchange gets lost between the remote and local replicas, Microsoft Jet replication's error-correcting protocol rejects the new message and requests a resend of the lost generations.

4.3 Remote/Off-site/On Location Clients

When PC users are not connected to the VPL network, they can continue to use their cached budget and inventory data. As described above using the indirect synchronization method, the Microsoft Jet Database Replication engine records all updates on the “disconnected” PC machine. When the PC machine is reconnected to the VPL network, either through dial-up, LAN, WAN, or Internet connection, the user can initiate the data synchronization. The Synchronizer will deposit the file of local updates to the master database and receive a file of changes made to the master since the last connection.

4.4 Conflict Detection and Resolution

When two users simultaneously update data, there are three possible outcomes:

The synchronization results in transparent updates with no errors or conflicts.

A conflict occurs because the two users have updated the same record.

An error occurs because the changes made by the user cannot be resolved in synchronization.

The first case is the most common; in well-designed replicable database applications, users can simultaneously update data without any adverse side effects. However, if two or more users modify the same record at the same time, conflicts or errors can occur.

A conflict occurs when two users update the same record. When this happens, Microsoft Jet replication chooses one replica to win the conflict and one to lose. The record from the winning replica is placed in the table and replicated to the rest of the replica set. The losing record is returned to the loser, and reported in a special table. The user of the losing replica is notified that conflicts exist and is prompted to either reapply the data or delete it. Conflicts do not cause the data in the replica set to diverge, and are usually a minor problem that is easily fixed.

Errors are simultaneous changes that can cause divergence in the data stored in the conflicting replicas. For example, an error occurs if users at two or more replicas simultaneously insert a new record and both records use an index value that was previously defined as unique. When the replicas attempt to synchronize, a duplicate key error will be returned. The user will be notified to correct the problem or reject the change.

4.5 Data Maintenance

Microsoft Jet provides utilities for database maintenance:

It is advised to compact replicas before synchronizing them. In fact, there is usually a benefit in compacting twice before synchronizing. The first time a replica is compacted, the compact utility reclaims unused pages on disk, making the database smaller. In addition, for replicated databases, the utility looks at the list of design changes that would be sent to a remote site and deletes those changes that are no longer relevant. These irrelevant changes usually occur where numerous modifications were made to a form, report, or code module object. Microsoft Jet replication keeps a copy of each changed version of an object, whereas only the latest version is actually used. When the compact utility is run the first time, these old versions of an object are marked as “no longer needed.” When the compact utility is executed the second time, these pages are reclaimed from the disk.

If the Database Replication engine detects that a replica is corrupt, it is best to create a new replica from the master database and discard the corrupted replica.

5 Use Cases

This section describes the primary actors in the VPL system and the main use cases or functions the actors will perform. The main use cases are shown in the use case diagrams attached as a part of Appendix “A.” Each of the use cases will be discussed in the following sections.

5.1 Actors

An actor is a kind of object outside the domain of the system itself that interacts directly with the system. The users and any system that may interact with the system are actors. Since actors represent system users, they help delimit the system and provide an overview and high-level details of the system functionality.

5.1.1 Production

The production client creates the budget and performs all of the services and functionality that are required to maintain the budget. The production company or studio will require its unique sub domain. The production sub domain will be used to facilitate the production budgeting functionality and synchronization. Production budgeters improve their management by employing VPL with the result of efficient and effective production budgeting and tracking. Budgeting is facilitated via PC's interfaces and unique budget tree along with the integration with the Vendor Client's database. Executives, line producers, department heads and accountants functionality is facilitated through the VPL PC's budgeting platform.

The types of production client actors are as follows:

PC Super User—manage users and budgets

Original Budgeter—create budget and produce initial (original) budget

Working Budgeter—works on the current (working) budget after the initial budget has been locked

Department Working Budgeter—works on the budget at the department level

Accountant—Approves budget line item/PO

5.1.2 Vendor

The vendor is the provider of product and services to the budgeted production. The vendor may require its unique sub domain. The vendor sub domain will be used to facilitate their Clients' budget management. The vendor sub domain is used to facilitate access to private areas set aside for and designated by VPL Admin. Vendors improve the management and visibility of their inventory with the result of better, more effective, service for their customers. Inventory management is facilitated via VC's interface to its inventory display platform and its integrated purchase order and invoice tracking functionality. Customer service is facilitated via the VPL interfaces and tracking platform.

The types of production client actors are as follows:

VC Super User—manage users and inventory

VC User—Service requests from PC users

5.1.3 VPL Admin

The VPL Admin has the ability to provide users with access and privileges to VPL. VPL Admin is responsible for providing new vendors and studios or the like with access to VPL. VPL Admin also mediates database read/write discrepancies. VPL Admin also has access to the vendor and production platform and all functionality, data, and modules of the VPL for use in providing backup to the budgeters for operational support and to the vendor for providing customer service. The system supports a hierarchy of VPL users with differing levels of access set per VPL Admin and Super users internal preferences and security procedures.

5.2 Use Cases

Production and Vendor Client use cases outline processes and tasks performed by the Production and Vendor Client. See the use case diagrams for the PC and VC Use Cases outlined in the attached Appendix “A.”

5.2.1 PC Super User

PC Super User's main responsibility is to maintain users and budgets.

5.2.1.1 Login/Logout

This use case enables the PC Super User to login to VPL and perform PC Super User specific actions. Upon login, the PC Super User specific screen is displayed. The user logs out by clicking on the logout button.

5.2.1.2 Add/Edit/Delete PC User

This use case enables the PC Super User to add, edit or delete a PC user. Before a user can be added to a budget user list, a super user must create the user.

5.2.1.3 Archive Budget

This use case enables the PC Super User to archive away a budget. Once a budget is archived, the budget users will not be able to open the budget.

5.2.1.4 Restore Budget

This use case enables the PC Super User to restore a budget from archive. After a budget has been restored, the budget users will be able to once again open the budget.

5.2.1.5 Delete Budget

This use case enables the PC Super User to delete budgets from the production workspace.

5.2.2 PC Users

PC Users use cases are uses cases that can be performed by Original Budgeters, Working Budgeters, Department Working Budgeters, and Accountants.

5.2.2.1 Login/Logout

This use case enables the PC Users to login to VPL and perform specific user tasks. Upon login, the PC user specific screen is displayed. The user logs out by clicking on the logout button.

5.2.2.2 Open Budget

This use case enables the PC user to open a budget. The user is presented with a list of budgets that he is allowed to open. When the budget is opened, the user is allowed to view and edit and perform specific tasks based on his user type.

5.2.2.3 Generate Request

This use case enables the PC user to generate a request to one or more vendors. A request is can be a request for specific item(s), request for hold, or a PO.

5.2.2.4 View Request Result

This use case enables the PC user to view the results for a specific request by the user. The user can view the result then accept it, generate another request based on the result or not take any further action.

5.2.2.5 View/Export/Print Report

This use case enables PC users to review or create reports online. Daily default reports are maintained in the database and available for display. Additionally, users can opt to create temporary reports for review for analysis purposes. The review of reports is often used to track the thought process used for strategizing the production, budget or inventory management process.

Reports can be exported to Word, Excel, Lotus, RTF, PDF, or other VPL specified formats. Reports include budget, inventory, ordering, invoice, contacts, and customized reports. Reports can also be printed.

5.2.2.6 Send/Receive Message

This use case enables the PC user to send and receive messages to PC and VC clients.

5.2.2.7 Work Off-line

This use case enables PC users to work off line. All database transactions performed during the off-line session are recorded for later synchronization. When users return to an online environment, VPL updates synchronizes the off-line transactions and uploads them to its system and downloads a refresh of the updated database to its PC client.

5.2.3 PC Original Budgeter User Specific

PC Original Budget use cases are uses cases that can be performed by Original Budgeters only. PC Original Budgeters are a type of super user, with rights to generate new budget, archive, delete and rename existing budgets, lock budgets and add access to locked budgets.

5.2.3.1 Create Budget

This use case enables the original budgeter to create a budget. Only the original budget is able to create a new budget.

5.2.3.2 Edit Original Budget

This use case enables the original budgeter to edit the budget before being locked. After the budget is locked, the original budgeter may edit the working budget.

5.2.3.3 Lock Original Budget

This use case enables the original budgeter to lock a budget. Once the original budget is locked, designated users can open the budget and edit either the working budget or the department working budget, depending on the user type.

5.2.3.4 Edit Working Budget

This use case enables the original budgeter to edit the budget after a budget has been locked. The original budgeter will be able to see the original budget line items along side the working budget line items.

5.2.3.5 Add/Edit/Delete User to Budget

This use case enables the original budgeter to add/edit/delete budget users.

5.2.3.6 Set User Permission

This use case enables the original budgeter to set user permission on a budget. The user permission will control what budget lines the user has ability to view/edit/delete.

5.2.3.7 Add/Edit/Delete Key Crew

This use case enables the original budgeter to add/edit/delete key crew for a budget.

5.2.3.8 Add/Edit/Delete Production/Studio/Other Info

This use case enables the original budgeter to add/edit/delete Production, Studio, and any other budget related information.

5.2.4 PC Working Budgeter User Specific

PC Working Budgeter works on the budget after a budget has been locked.

5.2.4.1 Edit Working Budget

This use case enables the working budgeter to edit the budget after a budget has been locked. The working budgeter will be able to see the original budget line items along side the working budget line items.

5.2.5 PC Department Working Budgeter User Specific

PC Working Budgeter works on the budget after a budget has been locked. Budget is edited at the department level.

5.2.5.1 Edit Department Working Budget

This use case enables the department working budgeter to edit the budget after a budget has been locked. The department working budgeter will be able to see the working budget line items along side the department working budget line items.

5.2.6 PC Accountant User Specific

The PC Accountant user's primary responsibility is to approve budget line items.

5.2.6.1 Approve Budget Item

This use case enables the PC Accountant user to approve a budget item. The user will be able to view all the line items requiring approval. The user will be able to view the working and department working budget, along with the details of a line item.

5.2.7 VC Super User Specific

The VC Super User is mainly responsible for managing VC users and managing inventory.

5.2.7.1 Add/Edit/Delete Users

This use case enables the VC super user to add/edit/delete VC users.

5.2.7.2 Set user permission

This use case enables the VC super user to set VC user permission. The user permission will control what inventory items, and item properties are shown to a user.

5.2.7.3 Manage Inventory

This use case enables the VC super user add to the inventory either item by item, or in a batch process. The VC super user will also be able to edit and delete inventory items.

5.2.8 VC Super User and VC User

These use cases can be performed by both the VC super user and the VC user.

5.2.8.1 Login/Logout

This use case enables the user to login and perform specific user tasks. Upon login, the user specific screen is displayed. The user logs out by clicking on the logout button.

5.2.8.2 View/Print/Export Reports

This use case enables the user to review or create reports online. Daily default reports are maintained in the database and available for display. Additionally, users can opt to create temporary reports for review for analysis purposes. The review of reports is often used to track the thought process used for strategizing the production, budget or inventory management process.

Reports can be exported to Word, Excel, Lotus, RTF, PDF, or other VPL specified formats. Reports include inventory, invoice, contacts, and customized reports. Reports can also be printed.

5.2.9 VC User Specific

VC users service PC users requests.

5.2.9.1 View Request

This use case enables the VC user to view requests. The requests can be ordered by request title, requester, request date, and request status.

5.2.9.2 Edit Request

This use case enables the VC user to edit a request. When a request cannot be fully fulfilled, VC user can edit a request, and send the request back to the PC user for approval.

5.2.9.3 Reply to Request

This use case enables the VC user to reply to a request. The user can reply to a request in several ways: accept, accept with changes, or not accept.

5.2.9.4 Read/Send Message

This use case enables the VC user to send and receive messages to PC and VC clients.

5.2.10 VPL Admin

VPL Admin is responsible for managing setup of new VPL clients, and managing the VPL database.

5.2.10.1 Setup Production Client

This use case enables the VPL Admin to setup a new production client. VPL Admin inputs global production information, and builds customized templates and lists.

5.2.10.2 Setup Vendor Client

This use case enables the VPL Admin to setup a new vendor client. VPL Admin inputs global production information, and builds customized templates and lists.

5.2.10.3 Add/Edit/Delete PC User

This use case enables the VPL Admin to create PC users. VPL Admin generally creates just the super users. The super users then create regular PC users.

5.2.10.4 Add/Edit/Delete VC User

This use case enables the VPL Admin to create VC users. VPL Admin generally creates just the super users. The super users then create regular VC users.

5.2.10.5 Maintain VPL DB

This use case enables the VPL Admin to manage the VPL database. The VPL Admin performs the following tasks:

Creates tables for PC client

Creates tables for VC client

Resolve database merge conflict

Monitors database status—size, access speed

Run database optimization

Run database backup

6 System Design

6.1 Overview

At the highest level, VPL is broken up into 3 main packages: VPL Database (VPLDB), PC Program, and VC Program. The PC and VC are dependent on VPLDB (This implies that change in VPLDB may necessitate changing PC and/or VC). There is no direct dependency between PC and VC. The communication between PC and VC is achieved by updating tables in the VPLDB.

[image]

6.2 Software Components

6.2.1 PC

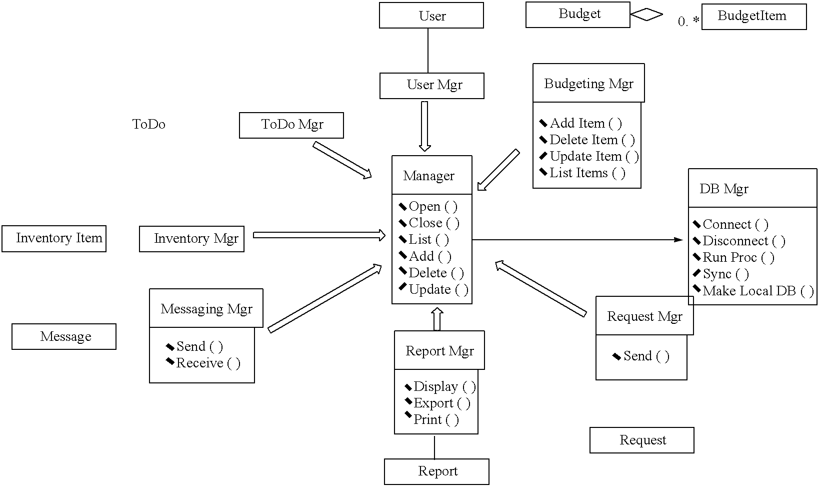

6.2.1.1 DB Manager

This module is responsible for communicating and transacting with VPLDB. All data access by PC modules is accomplished using this module.

6.2.1.2 User Manager

This module is responsible for managing users. This module is used to add, delete, and update user information.

6.2.1.3 Budgeting Manager

This module is responsible for managing the budgeting process. This module is used to create, open, edit, and close a budget.

6.2.1.4 Request Manager

This module is responsible for managing requests. This module is used to create, list, open, edit and delete requests. This module is also used to view replies for requests.

6.2.1.5 Report Manager

This module is responsible for displaying, printing, and exporting pre-made reports, as well as creating new reports dynamically.

6.2.1.6 Messaging Manager

This module is responsible for managing messages. This module is used to create, open, send, and receive messages.

6.2.1.7 Inventory Manager

This module is responsible for managing vendor inventory. This module is used to list inventory items from selected vendors.

6.2.1.8 ToDo Manager

This module is responsible for managing the To Do list. This module is used to create, list, open, edit, and delete To Do items.

6.2.2 VC

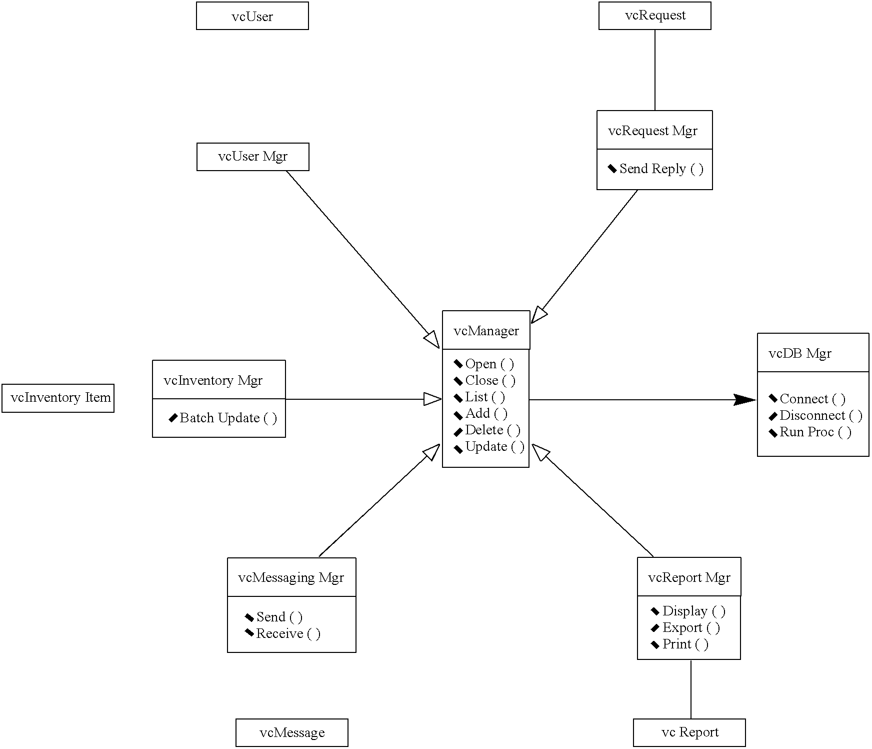

6.2.2.1 DB Manager

6.2.2.2 User Manager

This module is responsible for managing users. This module is used to add, delete, and update user information.

6.2.2.3 Request Manager

This module is responsible for managing requests. This module is used to reply to requests from PC clients.

6.2.2.4 Report Manager

This module is responsible for displaying, printing, and exporting pre-made reports, as well as creating new reports dynamically.

6.2.2.5 Messaging Manager

This module is responsible for managing messages. This module is used to create, open, send, and receive messages.

6.2.2.6 Inventory Manager

This module is responsible for managing vendor inventory. This module is used to add, delete, and update inventory items.

6.2.3 Database

6.2.3.1 PC Tables

6.2.3.1.1 Budget

The budget able contains the budget overview information, including if the budget is locked or not.

| | | |
|---|---|---|
| BudgetID | Text(50) | System provided budget ID |
| BudgetName | Text(254) | Budget Name |
| Show | Text(100) | Show Title |
| Desc | Text(254) | Description of the budget |
| BudgetType | Text(15) | Budget Type-TV, Film, Commercial |
| LockedOrigBudget | Y/N | Yes-locked No-not locked |
| StartDate | Date | Start of Budget |
| EndDate | Date | End of Budget |
| StartShoot | Date | Start Date of Shoot |
| EndShoot | Date | End Date of Shoot |
| Logo | Text(254) | File name |

6.2.3.1.2 Purchase Orders

The budget able contains the purchase order information. This table is linked to the POLines table which details the lines of the purchase order.

| | | |
|---|---|---|
| BudgetID | Text(50) | System provided budget ID |
| POID | Text(100) | Purchase Order ID generated via VPL |
| VendorID | Long | Vendor ID |
| PO Desc | Text(254) | General PG Description |
| PODate | Date | Purchase Order Date |
| POAmt | Double | Total Amount |
| Approved | Text(100) | UserID |
| IssuedBy | Text(100) | UserID |
| POType | Text(10) | Request, Hold, PO |
| ShipTo | Memo | Address |
| Conments | Memo | Comment Field |
| CurrencyID | Text(5) | CurrencyID |

6.2.3.1.3 Vendor

This table contains vendor contact and general information.

| | | |
|---|---|---|
| VendorID | Long | VPL assigned ID |
| VendorName | Text(255) | Vendor Name |
| ContactLname | Text(100) | Contact Last Name |
| ContactFname | Text(100) | Contact First Name |
| Address | Text(254) | Street Address |
| City | Text(50) | City |
| State | Text(20) | State |
| Country | Text(10) | Country |
| Phone | Text(20) | Phone |
| Fax | Text(20) | Phone |
| Email | Text(100) | Email |
| CurrencyID | Text(5) | VPL assigned ID |
| Category | Text(50) | VPL defined category |
| SubCategory | Text(50) | VPL defined sub-category |
| LineIDCm | Double | Commercial Line Reference |
| LineIDFilm | Double | Film Budget Line Reference |
| LineIDTV | Double | TV Budget Line Reference |

6.2.3.2 VC Tables

6.2.3.2.1 Inventory

This table contains inventory that is provided by the vendor.

6.2.3.2.2 Rate Cards

This table contains rate card information that is provided by the vendors.

6.2.3.2.3 Vendor

This table contains vendor contact information.

7 Risk Management

7.1 Unresolved Issues

The length of processing time required for synchronizing the database. Users who work offline must synchronize their databases. The time required to update and resolve conflicts is an unkown.

Users working offline for lengthy periods may have more unresolved database conflicts. The acceptable amount of time or rules by which conflicts are resolved is undefined. The number of VPL analysts required for resolving database conflicts is dependent on the accuracy, consistency, and robustness of the database synchronization.

The downloads and uploads require monitoring to assess the requisite number of analysts.

The profile of the budgets being processed should be further researched to streamline budgeting and scheduling processes.

7.2 Assumptions

7.2.1 Scheduling

Integration with scheduling software is required to fully encapsulate the production process. There are a few major providers of scheduling software. These providers have little facility for uploading the requisite information. More research is required to understand the design and implementation of scheduling and accounting feeds to the VPL system.

7.2.2 Budget Types

Commercials and motion picture budget templates have been created using 5 levels of a budget hierarchy representing the general ledger. For other types of productions, the general ledger numbers must also be able to accommodate 5 levels for easy integration with the current VPL structure.

7.2.3 Other Risks

Unforeseen difficulty in acquiring data, models, analytics and report writers. New types of productions are created which are not handled by our system. Server and redundant server failure.

Insufficient expert bandwidth to support the number of accessed productions. Insufficient customer service bandwidth to support the customer service requests.

8 Diagrams

PC Diagram:

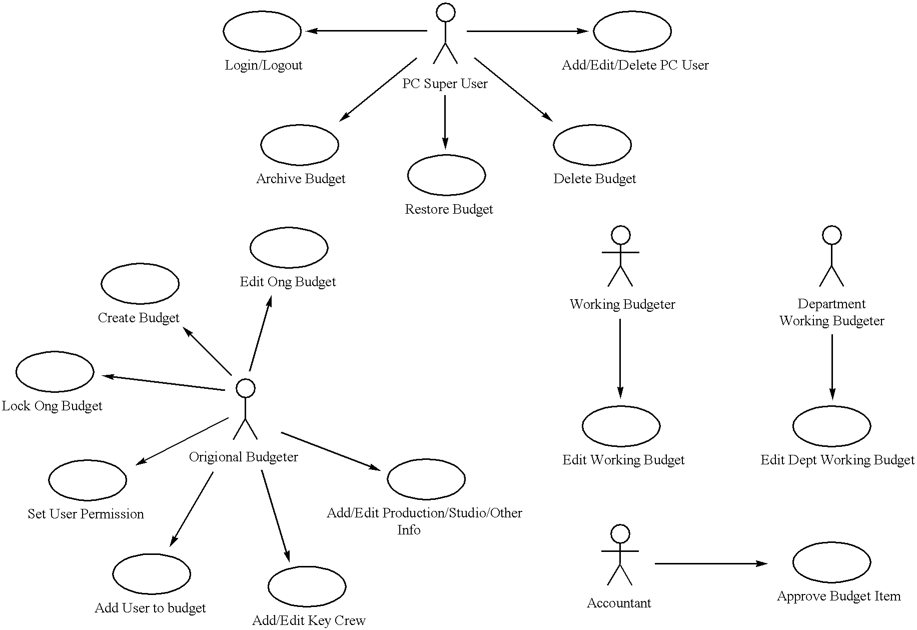

PC User Diagram:

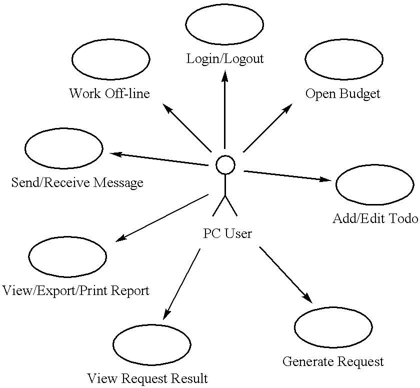

Vendor Diagram:

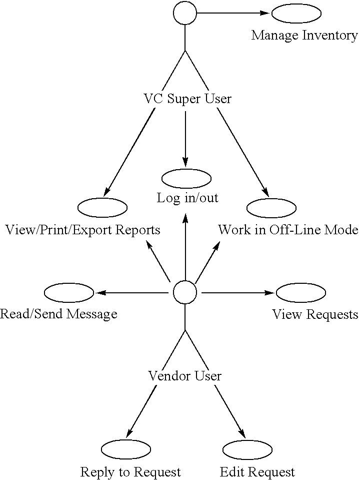

VPL Admin:

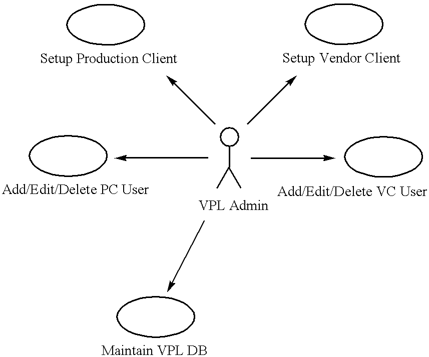

In closing, it is to be understood that the foregoing detailed description and accompanying drawings relate to preferred embodiments of the invention. However, the invention may be implemented by alternative arrangements which are comparable in function to those disclosed herein. Accordingly, the present invention is not limited to the exact embodiments as described in the present specification and drawings.

What is claimed is:

1. A virtual production link system for media production comprising:
a vendor data base including at least a majority of the following vendors:
a) camera rental and sales companies;
b) audio equipment rental and sales companies;
c) lighting rental and sales companies;
d) grip rental and sales companies;
e) video rental and sales companies;
f) expendables sales companies;
g) wardrobe rental and sales companies;
h) set construction companies;
i) film and video sales companies;
j) media transportation rental and sales companies;
k) media production construction companies;
a service company data base including at least a majority of the following:
a) accounting services companies;
b) payroll services companies;
c) location services companies;
d) studio or stage rental companies;
e) studio or stage services companies;
f) film permit services companies;
g) security services companies;
h) art services companies;
i) food services companies;
j) labor services companies;
k) post production services companies;
l) music services companies;
m) research services companies;
n) legal services companies;
o) creative services companies;
p) special effects companies;
q) promotion services companies; and
r) shipping services companies;
said vendor and service data bases including date availability information;
a budget program coupled to receive vendor and service information; and
an auction program for permitting vendors and service providers to bid on selected requirements.

2. A virtual production link system as defined in claim 1 wherein individual production users are coupled to said system to input production needs, and to receive availability and budget information.

3. A virtual production link system as defined in claim 1 further including access arrangements to permit review of budget and production information by an authorized additional entity.

4. A virtual production link system comprising:
a vendor data base including a plurality of vendors;
a service company data base;
said vendor and service data bases including date availability information;
a budget program coupled to receive vendor and service information;
an auction program for permitting vendors and service providers to bid on selected requirements; and
input circuitry for coupling production users to said system to input production needs, and to receive availability and budget information.

5. A virtual production link system as defined in claim 4 further including access arrangements to permit review of budget and production information by an authorized additional entity.

6. A virtual production link system comprising:
a vendor data base including a plurality of vendors;
said vendor data base including date availability information;
a budget program coupled to receive vendor and service information; and
input circuitry for coupling production users to said system to input production needs, and to receive availability and budget information.

7. A system as defined in claim 4 further including an auction program for permitting vendors to bid on requested requirements.

8. A virtual production link system as defined in claim 6 further including access arrangements to permit review of budget and production information by an authorized additional entity.
